(19) United States
(12) Patent Application Publication
(10) Pub. No.: US 2026/0194958 A1
(43) Pub. Date: Jul. 9, 2026

(54) POWER SAVING FUNCTION CONTROL DEVICE, CALCULATION SYSTEM, POWER SAVING FUNCTION CONTROL METHOD, AND PROGRAM

(71) Applicant: NIPPON TELEGRAPH AND TELEPHONE CORPORATION, Tokyo (JP)

(72) Inventor: Tetsuro TOKUNAGA, Tokyo (JP)

(73) Assignee: NIPPON TELEGRAPH AND TELEPHONE CORPORATION, Tokyo (JP)

(21) Appl. No.: 19/134,228

(22) PCT Filed: Dec. 9, 2022
(86) PCT No.: PCT/JP2022/045548

§ 371 Date: May 30, 2025

(51) Int. Cl. G06F 1/3234; G06F 1/3209

(52) U.S. Cl. CPC G06F 1/3243; G06F 1/3209

(57) ABSTRACT

Provided is an active core number controller that controls a power saving function of a CC-state controller in a control target server of a wireless system that reduces a power consumption amount by gradually reducing an operating state of a processor according to a processing load, the active core number controller including a rule accumulator that accumulates a rule for a power saving function for each control target server acquired from the outside, and a rule reflector that performs power saving function control reflecting the rule on the power saver in accordance with the rule accumulated in the rule accumulator.

### CROSS-REFERENCE TO RELATED APPLICATION

This application is a national stage application, pursuant to 35 U.S.C. § 371, of International Patent Application No. PCT/JP2022/045548, filed Dec. 9, 2022, the entire contents of which is incorporated herein by reference.

### TECHNICAL FIELD

The present invention relates to a power saving function control device, a calculation system, a power saving function control method, and a program.

### BACKGROUND ART

When the amount of data processed by a computer increases or the number of communication partners increases, the power consumption of the computer increases. Although there are maximum values for power consumption and maximum amounts of data that can be processed, there is generally a correlation between them. There are several existing methods for reducing power consumption.

For example, in a case where a CPU of a multi-core processor performs processing, the processing is assigned to a core, and the core performs the processing. The assignment function may be implemented either by using the function provided by the OS or by software. At this time, not all the cores are operating.

If a CC-state (described later) having a high degree of power saving can be set for an inactive core, power consumption can be reduced. At this time, the CPU usage rate is not necessarily 100%. In addition, power consumption can be reduced by using processor power state (C-state) (described later) control, processor performance state (P-state) (described later) control, power capping (power limit) functions, and the like (Non-Patent Literature 1). The power capping function is described in Non-Patent Literature 1. [Low Power Idle (LPI) Hardware Control]

The CPU has a function of controlling an idle state of the CPU through hardware control, which is called LPI. The LPI is often referred to as CPUidle or C-state, and hereinafter, the LPI will be described as C-state.

When the CPU load decreases, the C-state attempts to save power by turning off the power to part of the CPU circuitry (Non-Patent Literature 1).

FIG. 26 is a table showing an example of a power mode “C-state” of the CPU. Note that since state definitions vary depending on the CPU hardware, FIG. 26 is merely a reference example.

As shown in FIG. 26, there are grades C0 to C6 in the CPUidle state, and the CPUidle state transitions to a deeper sleep state as the time during which the CPU is not loaded becomes longer. The CPU power consumption becomes smaller in a deeper sleep state, but on the other hand, the time required for the return becomes longer accordingly, which may be a problem from the viewpoint of low delay.

The C-state has different state definitions depending on the CPU hardware. For example, there are variations such as a model without C4 or C5, and a model in which the state subsequent to C1 is a CIE state.

As the state becomes deeper, the power saving effect increases, but the time required to return from the idle state also increases accordingly.

In addition, the depth to which the CPUidle state transitions is controlled by the CPU hardware and is dependent on a CPU product (in many cases, it cannot be controlled by software such as a kernel).

FIG. 27 is a table showing an example of a power mode “CC-state” of a CPU core.

In recent years, a CPU has often been a multi-core processor equipped with a plurality of “processor cores”, each of which operates independently like a single processor. Core-based C-states are called “CC-states”.

As shown in FIG. 27, the CC-state includes grades CC0 to CC7. Clock gating, shown as CC1 and CC3 in FIG. 27, removes the clock signal when the circuit is not in use. Clock gating is a common technique used in many synchronous circuits to reduce dynamic power dissipation.

The CC-state has different state definitions depending on the CPU hardware. As the state becomes deeper, the power saving effect increases, but the time required to return from the idle state also increases accordingly.

FIG. 28 is a table showing an example of a power mode “PC-state” of a CPU package.

As shown in FIG. 28, the PC-state includes grades PC0 to PC7. The entire multi-core processor is called a package, and package-based C-states are called “PC-states”. The PC-state has different state definitions depending on the CPU hardware. As the state becomes deeper, the power saving effect increases, but the time required to return from the idle state also increases accordingly.

Further, processor performance states (P-states) indicate the state of the performance setting of the CPU. The P-state is a performance setting for an operating frequency and a voltage of the CPU. The higher the number following the P, the lower the frequency and voltage at which the processor will operate, resulting in less power consumption. The number following the P is processor-specific, and the frequency and voltage will vary depending on the processor. P0 is the state that provides the best performance.

The C-state (FIG. 26) and the P-state are independent mechanisms.

Non-Patent Literature 2 describes that, in the C-state, when a state in which power usage is suppressed is set, the time required to return from the power suppression state increases.

### CITATION LIST

### Non-Patent Literature

Non-Patent Literature 1: Pawa kyappingu (denryoku seigen) kino: Denryoku shohi no jogen o settei suru kino (in Japanese) (Power capping (power limit) function: A function to set an upper limit on power consumption), [online], [Retrieved on Dec. 1, 2022], Internet <URL: https://access.redhat.com/documentation/ja-jp/red_hat_enterprise_linux/6/html/power_management_guide/power_capping> Non-Patent Literature 2: As the C-States get deeper, the exit latency duration becomes longer (the time to transition to C0) and the power savings becomes greater., [online], [Retrieved on Dec. 1, 2022], Internet <URL: https://www.intel.com/content/www/us/en/develop/documentation/energy-analysis-user-guide/top/energy-analysis-metrics-reference/c-state.html>

### SUMMARY OF INVENTION

### Technical Problem

However, in the technologies described in Non-Patent Literatures 1 and 2, if the CC-state (FIG. 27) of an inactive core and the C-state (FIG. 26) and the P-state of a CPU are set to deeper states, or if a power capping function or the like is used and a state of reduced power usage is set, the time required to return from an idle state, a low frequency state, or a power suppression state will also increase.

If the time required to return from these states to a state where the processing volume is high and processing speed should be prioritized over power suppression is long, a processing delay will occur. Conversely, if the CC-state of an inactive core and the C-state and P-state of the CPU are always set to shallow states to avoid processing delays, or if the power capping function is used to suppress power consumption weakly or these settings are disabled, more power than necessary will be consumed.

The present invention has been made in view of the above background, and an object of the present invention is to reduce power consumption without causing delays in power saving function control of a CPU.

### Solution to Problem

In order to solve the above-mentioned problems, there is provided a power saving function control device that controls a power saving function of a power saver in a control target server of a calculation system that reduces a power consumption amount by gradually reducing an operating state of a processor according to a processing load, the power saving function control device including a rule accumulator that accumulates a rule for a power saving function for each control target server acquired from the outside, and a rule reflector that performs power saving function control reflecting the rule on the power saver in accordance with the rule accumulated in the rule accumulator.

### Advantageous Effects of Invention

According to the present invention, power consumption can be reduced without causing delays in power saving function control of a CPU.

### BRIEF DESCRIPTION OF DRAWINGS

FIG. 1 is a schematic configuration diagram of a wireless system according to a first embodiment of the present invention.

FIG. 2A is a configuration diagram of a base station including a control target server having a power saving function control device according to the first embodiment of the present invention, a control device, an aggregation device, and a terminal.

FIG. 2B is a configuration diagram of the base station in a case where the control target server having the power saving function control device according to the first embodiment of the present invention is arranged in a user space, the control device, the aggregation device, and the terminal.

FIG. 3 is a diagram showing, in the form of a table, an example of rules accumulated in a rule accumulator of a power saving function control device of a calculation system according to an embodiment of the present invention.

FIG. 4 is a diagram illustrating setting items of the rule table shown in FIG. 3.

FIG. 5A is a configuration diagram of a base station including a control target server having a power saving function control device according to a second embodiment of the present invention, a control device, an aggregation device, and a terminal.

FIG. 5B is a configuration diagram of the base station in a case where the control target server having the power saving function control device according to the second embodiment of the present invention is arranged in a user space, the control device, the aggregation device, and the terminal.

FIG. 6 is a diagram showing just-collected information temporarily accumulated in an information temporary accumulator of the power saving function control device of the calculation system according to the embodiment of the present invention.

FIG. 7 is a diagram showing an amount of passing data temporarily accumulated in the information temporary accumulator of the power saving function control device of the calculation system according to the embodiment of the present invention.

FIG. 8 is a diagram showing information on the number of connected terminals temporarily accumulated in the information temporary accumulator of the power saving function control device of the calculation system according to the embodiment of the present invention.

FIG. 9 is a diagram showing information on a usage rate of a CPU core accumulated in a data accumulator of the power saving function control device of the calculation system according to the embodiment of the present invention.

FIG. 10 is a diagram showing an amount of passing data accumulated in the data accumulator of the control device of the calculation system according to the embodiment of the present invention.

FIG. 11 is a diagram showing information on the number of connected terminals accumulated in the data accumulator of the control device of the calculation system according to the embodiment of the present invention.

FIG. 12 is an explanatory diagram for generating a rule on the basis of information on a plurality of control target servers of the power saving function control device of the calculation system according to the embodiment of the present invention.

FIG. 13A is an explanatory diagram for estimating the number of CPU cores that should be kept in operation from traffic and a CPU usage rate of each control target server of the power saving function control device of the calculation system according to the embodiment of the present invention.

FIG. 13B is an explanatory diagram for estimating the number of CPU cores that should be kept in operation from traffic and a CPU usage rate of each control target server of the power saving function control device of the calculation system according to the embodiment of the present invention.

FIG. 13C is an explanatory diagram for estimating the number of CPU cores that should be kept in operation from traffic and a CPU usage rate of each control target server of the power saving function control device of the calculation system according to the embodiment of the present invention.

FIG. 14A is an explanatory diagram for estimating the number of CPU cores that should be kept in operation from a CPU usage rate and the number of terminals being connected to each control target server of the calculation system according to the embodiment of the present invention.

FIG. 14B is an explanatory diagram for estimating the number of CPU cores that should be kept in operation from a CPU usage rate and the number of terminals being connected to each control target server of the calculation system according to the embodiment of the present invention.

FIG. 14C is an explanatory diagram for estimating the number of CPU cores that should be kept in operation from a CPU usage rate and the number of terminals being connected to each control target server of the calculation system according to the embodiment of the present invention.

FIG. 15A is an explanatory diagram for estimating the number of CPU cores that should be kept in operation from traffic, the number of connected terminals, and a CPU usage rate of each control target server of the calculation system according to the embodiment of the present invention.

FIG. 15B is an explanatory diagram for estimating the number of CPU cores that should be kept in operation from traffic, the number of connected terminals, and a CPU usage rate of each control target server of the calculation system according to the embodiment of the present invention.

FIG. 16 is a diagram showing, in the form of a table, an example in which the number of CPU cores that should be kept in operation is estimated from traffic and a CPU usage rate of each control target server of the calculation system according to the embodiment of the present invention, and is held in the data accumulator.

FIG. 17 is a diagram showing, in the form of a table, an example in which the number of CPU cores that should be kept in operation is estimated from the number of terminals and a CPU usage rate of each control target server of the calculation system according to the embodiment of the present invention, and is held in the data accumulator.

FIG. 18 is a diagram showing, in the form of a table, an example in which the number of CPU cores that should be kept in operation is estimated from traffic, the number of connected terminals, and a CPU usage rate of each control target server of the calculation system according to the embodiment of the present invention, and is held in the data accumulator.

FIG. 19A is a configuration diagram of a base station including a control target server having a power saving function control device according to a third embodiment of the present invention, a control device, an aggregation device, and a terminal.

FIG. 19B is a configuration diagram of the base station in a case where the control target server having the power saving function control device according to the third embodiment of the present invention is arranged in a user space, the control device, the aggregation device, and the terminal.

FIG. 20 is a diagram showing information on an IP address of a control target server, a hostname of the control target server, and latitude and longitude, which are arrangement places of the control target server, accumulated in a data accumulator of a power saving function control device according to a fourth embodiment of the present invention.

FIG. 21 is a diagram showing information on an IP address of a control target server, a hostname of the control target server, attribute information (DU attribute) of the control target server, and latitude and longitude, which are arrangement places of the control target server, accumulated in the data accumulator of the power saving function control device according to the fourth embodiment of the present invention.

FIG. 22 is a diagram showing, in the form of a table, an example in which the number of CPU cores that should be kept in operation is estimated from traffic, the number of connected terminals, and a CPU usage rate of each control target server of the calculation system according to the fourth embodiment of the present invention, and is held in the data accumulator.

FIG. 23A is a configuration diagram of a base station including a control target server having a power saving function control device according to a fifth embodiment of the present invention, a control device, an aggregation device, and a terminal.

FIG. 23B is a configuration diagram of the base station in a case where the control target server having the power saving function control device according to the fifth embodiment of the present invention is arranged in a user space, the control device, the aggregation device, and the terminal.

FIG. 24 is a diagram showing information on an IP address of a control target server, a hostname of the control target server, attribute information (DU attribute) of the control target server, and latitude and longitude, which are arrangement places of the control target server, accumulated in a data accumulator of the power saving function control device according to the fifth embodiment of the present invention.

FIG. 25 is a hardware configuration diagram illustrating an example of a computer that implements functions of the power saving function control device of the calculation system according to the embodiment of the present invention.

FIG. 26 is a table showing an example of a C-state.

FIG. 27 is a table showing an example of a power mode “CC-state” of a CPU core.

FIG. 28 is a table showing an example of a power mode “PC-state” of a CPU package.

### DESCRIPTION OF EMBODIMENTS

A calculation system and the like in an embodiment for carrying out the present invention (hereinafter referred to as “the present embodiment”) will be described below with reference to the drawings.

### First Embodiment

### Overview

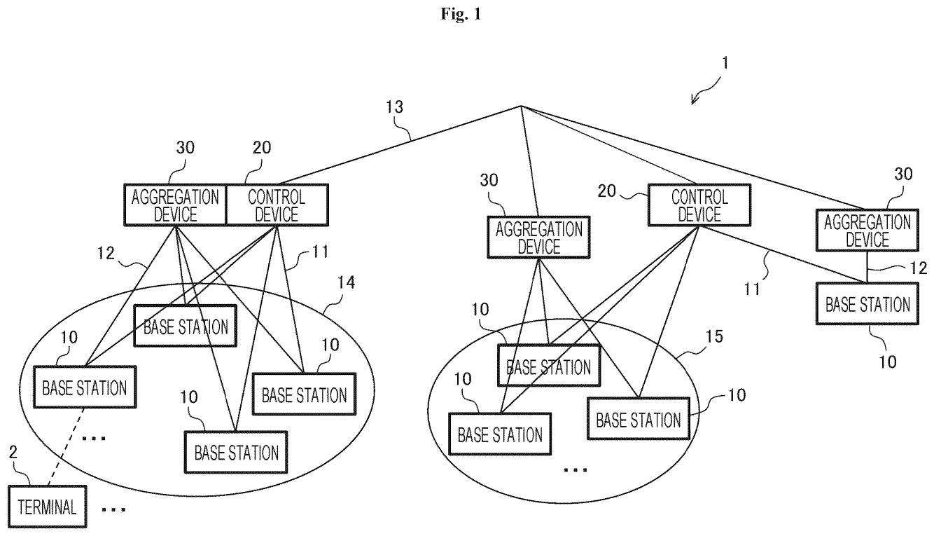

FIG. 1 is a schematic configuration diagram of a wireless system according to a first embodiment of the present invention. The present embodiment is an example applied to a wireless system as a calculation system.

A wireless system 1 includes a base station 10, a control device 20 which is in charge of the base station 10, an aggregation device 30 which is in charge of the base station 10, and a terminal 2. The aggregation device 30 aggregates a plurality of base stations 10 within communication areas 14 and 15.

The wireless system 1 includes a control device 20 which is in charge of a plurality of base stations 10 or a control device 20 which is in charge of a single base station 10. Which control device 20 is in charge of which base station 10 is set in advance. The control device 20 and the base station 10 are connected via a network 11. The base station 10 served by an arbitrary control device 20 and the base station 10 served by an arbitrary aggregation device 30 are not necessarily the same.

The base station 10 is a device that performs wireless communication with the terminal 2. Data can be transmitted and received via wireless communication. The wireless communication uses existing technologies such as New Radio (NR) and Long Term Evolution (LTE), but is not limited to these.

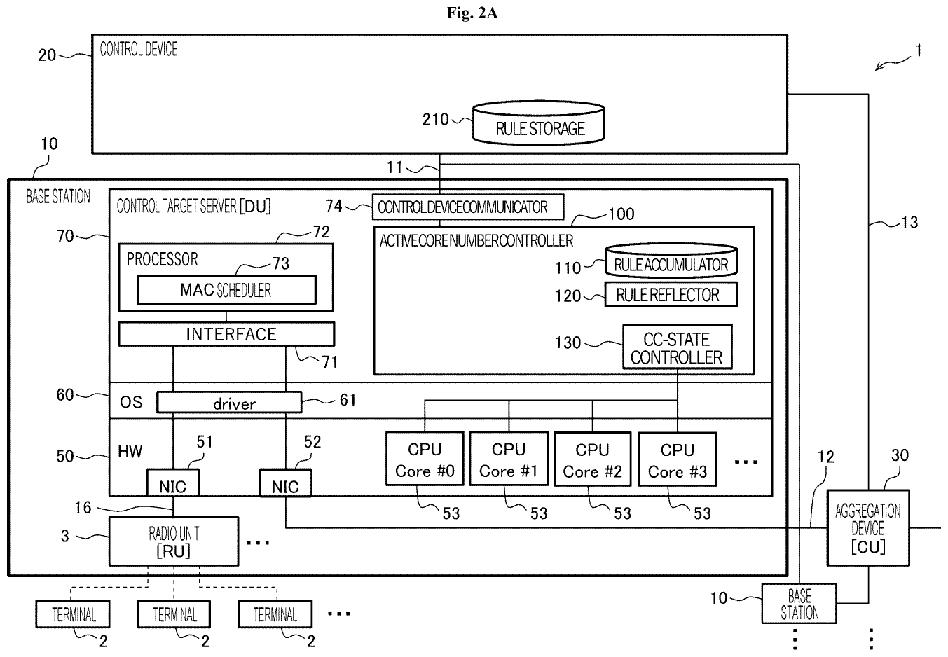

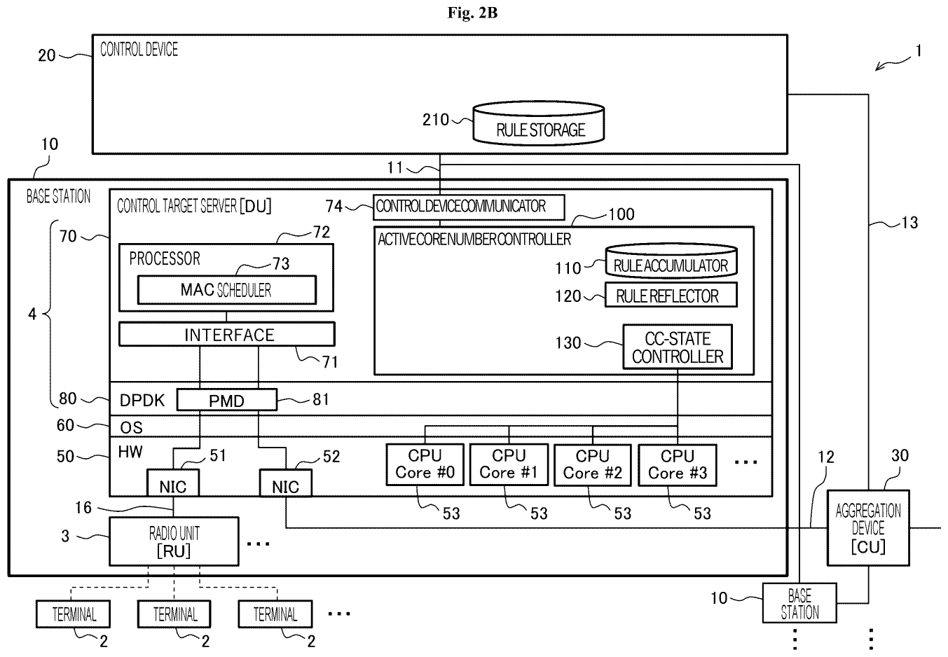

The base station 10 and the control device 20 are connected via a network 11, which is a dedicated communication path, and the control device 20 and the aggregation device 30 are connected via a network 13 (see FIG. 2).

FIG. 2A is a configuration diagram of a base station including a control target server (signal processing device) having a power saving function control device according to the first embodiment of the present invention, a control device, an aggregation device, and a terminal.

An overview of the wireless system 1 will be described.

The wireless system 1 includes a user terminal (user equipment: UE) 2, an antenna (base station antenna) (not illustrated), a base station (base band unit: BBU) 10, and a core network (not illustrated).

The antenna is an antenna and a transceiver unit that wirelessly communicates with the UE (hereinafter, “antenna” collectively refers to the antenna, the transceiver unit, and its power supply unit). The transmitted and received data is connected to the base station, for example, via a dedicated cable.

The core network is an evolved packet core (EPC)/(in the following description, “/” indicates “or”) 5G core network (5GC), etc.

A base station (BBU) in a radio access network (RAN) is an example of a system that requires real-time performance.

In a BBU that uses a CPU for arithmetic operations, the power saving function control device often assigns radio signal processing tasks to a CPU core to perform arithmetic operations.

The base station 10 is a stationary radio station located on land that performs wireless communication with the terminal [UE] 2. A base station (broad band unit: BBU) that performs radio signal processing is dedicated hardware (dedicated device) that performs radio signal processing. Alternatively, the base station is a virtual radio access network (vRAN) that uses general-purpose servers to process radio signals in Long Term Evolution (LTE) or five generation (5G) signal processing aggregation systems. In vRAN, a general-purpose server that is inexpensive and available in large quantities can be used as hardware of the base station.

For wireless communication, existing technologies such as New Radio (NR) and Long Term Evolution (LTE) are applied, but the technology is not limited to these.

The base station 10 includes a radio unit [RU] 3 which is a radio device of the base station, hardware (HW) 50, network interface cards (NICs) 51 and 52, a central processing unit (CPU) 53 on the hardware, an OS 60 having a driver 61, and a control target server [distributed unit: DU] 70 which is a signal processing device of the base station 10.

The control target computer of the wireless system 1 is a control target server 70 of the base station 10. The control target server 70 of the base station 10 includes a CPU 53 on its hardware. The CPU 53 has CPU cores (CPU core #0, CPU core #1, . . . ), and the CPU 53 executes, for example, L1, L2, and L3 protocol wireless signal processing applications (collectively referred to as APL).

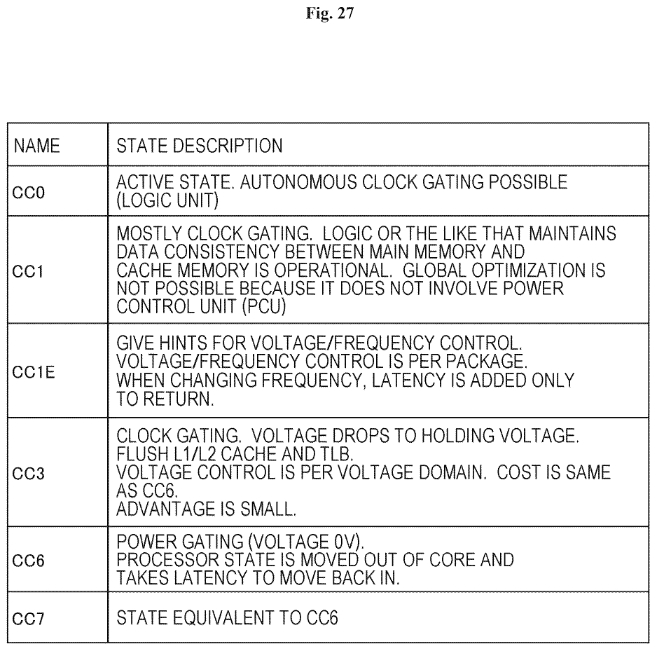

In the present embodiment, an example of controlling power consumption by a CC-state (FIG. 27) that controls the state of each CPU core will be described.

In addition to the CPU, the present invention is similarly applicable to other processors such as graphic processing units (GPUs), field programmable gate arrays (FPGAs), or application specific integrated circuits (ASICs) in a case where they have an idle state function.

The base station 10 is divided into three nodes: the radio unit [RU] 3, the control target server [DU] 70, and the aggregation device [central unit: CU] 30. By formulating an open interface between the nodes, it is possible to connect devices from a plurality of vendors.

### [Control Target Server 70]

The control target server 70 includes an interface 71, a processor 72 having a medium access control (MAC) scheduler 73, a control device communicator 74, and an active core number controller 100 (power saving function control device).

The processor 72 generates data in a format interpretable by the radio unit 3 and passes the data to the interface 71. In addition, the processor 72 generates data in a format interpretable by the aggregation device 30 and passes the data to the interface 71.

The MAC scheduler 73 holds the number of terminals [UE] 2 being connected via the radio unit [RU] 3.

The control device communicator 74 performs communication control between the base station 10 and the control device 20. The control device communicator 74 acquires rules from a rule storage 210 of the control device 20 and transmits the rules to the active core number controller 100.

### [Active Core Number Controller 100]

The active core number controller 100 includes a rule accumulator 110, a rule reflector 120, and a CC-state controller 130 (power saver).

The rule accumulator 110 accumulates rules adapted to the corresponding control target server 70 (described later).

The rule reflector 120 controls the CC-state via the CC-state controller 130 in accordance with the rules stored in the rule accumulator 110 (described later).

The CC-state controller 130 controls a CC-state (described later). In addition, for example, for a core or a core group of a processor used at a predetermined frequency or more, an upper limit is set so that the operating state of the processor cannot be transitioned to a deeper state.

Note that the CC-state controller 130 of the active core number controller 100 may be arranged within the OS 60.

### [Control Device 20]

The control device 20 includes a rule storage 210.

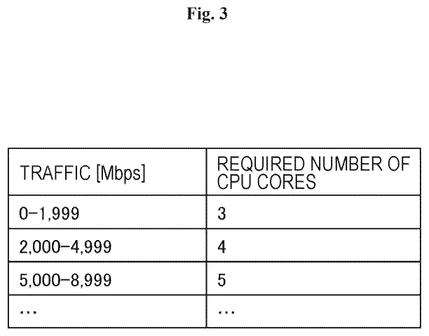

The rule storage 210 stores rules (see FIG. 3, which will be described later) adapted to the control target server 70 in each base station 10.

### <Arrangement of Control Target Server 70>

FIG. 2B illustrates an example of a configuration in which the control target server 70 in FIG. 2A is arranged in a user space 4. The same components as those in FIG. 2A are denoted by the same reference numerals, and the description of the overlapping parts will be omitted.

Software-based methods using Intel data plane development kit (Intel DPDK) (Intel is a registered trademark) (hereinafter referred to as DPDK), which is a high-speed packet processing library, have been proposed.

A DPDK is a framework for performing network interface card (NIC) control, which has conventionally been performed by a Linux kernel (registered trademark), in a user space. The largest difference from the processing in a Linux kernel lies in having a polling-based reception mechanism called a pull mode driver (PMD). Normally, in a Linux kernel, interruption occurs when data reaches the NIC, and reception processing is triggered by the interruption. On the other hand, in the PMD, a dedicated thread continuously performs data arrival checking and reception processing. By eliminating overheads such as context switches and interrupts, high-speed packet processing can be performed. The DPDK greatly improves the performance and the throughput of packet processing, allowing more time for data plane application processing.

The base station 10 illustrated in FIG. 2B includes, on a user space 4 usable by the user, a control target server 70, a DPDK 80 which is data high-speed transfer middleware arranged on the user space 4, and a packet processing application (APL) (not illustrated).

The DPDK 80 is a framework for controlling the NICs 51 and 52 in the user space 4, and specifically, the DPDK 80 includes a PMD 81 (a driver capable of selecting data arrival in a polling mode or an interrupt mode) which is a polling-based reception mechanism. In each PMD 81, a dedicated thread continuously performs data arrival checking and reception processing. If the NICs 51 and 52 receive a packet, the PMD 81 arranges the received packet in a packet buffer secured on Hugepage from the NICs 51 and 52.

The DPDK 80 polls and monitors packet reception using the packet processing API. The DPDK 80 realizes a packet processing function in the user space 4 where the APL operates, and enables reducing packet transfer delays by immediately harvesting packets when they arrive from the user space 4 using a polling model. In other words, the DPDK 80 harvests packets by polling (busy polling the queue in the CPU), and thus there is no waiting and there is little delay.

As described above, there are two patterns: a case where the driver 61 is in the space of the OS 60 as in the base station 10 illustrated in FIG. 2A; and a case where there is a PMD 81 (corresponding to the driver of the OS 60) in the user space 4 which is a layer above the OS 60 as in the base station 10 illustrated in FIG. 2B (at this time, the driver 61 of the OS space is not used).

The present invention can be applied to a case where there is a control target server in the user space, such as in the case of a DPDK.

### Other Application Examples

The present embodiment is an example applied to a wireless system as a calculation system, but is not limited to the wireless system. That is, the present invention can also be applied to a server other than the control target server 70 of the base station 10.

In this case, the “traffic volume” in the server (control target server 70) of the wireless system 1 corresponds to the “number of requests” received by the server and the “number of responses” transmitted by the server in a request-response type server. The “number of connected terminals” in the server (control target server 70) of wireless system 1 corresponds to the number of clients maintaining a connection state/session in the server of a stateful system.

Hereinafter, the operation of the wireless system 1 configured as described above will be described.

### [Operational Overview of Wireless System 1]

As illustrated in FIGS. 2A and 2B, the base station 10 includes a control target server 70 that is a signal processing device and a radio unit 3. There may be a plurality of radio units 3. The radio unit 3 is connected to the control target server 70 via a network, and is connected to the terminal 2 via wireless communication. The control target server 70 processes signals using the CPU 53 and other hardware and software.

DownLink (data reception from the aggregation device 30 to the control target server 70 to the radio unit 3) and UpLink (data transmission from the radio unit 3 to the control target server 70 to the aggregation device 30) will be described below.

### DownLink

The control target server 70 receives data from the aggregation device 30 via the network 12.

The interface 71 of the control target server 70 acquires data via the driver 61 of the OS 60 and the NIC 52, performs protocol processing on the acquired data packet, and passes the data to the processor 72.

The processor 72 generates data in a format interpretable by the radio unit 3 and passes the data to the interface 71.

The interface 71 passes data to the radio unit 3 via the driver 61 (in FIG. 2B, the PMD 81 of the DPDK 80) of the OS 60 and the NIC 51.

The radio unit 3 receives data from the control target server 70 via a network 16. The radio unit 3 passes data to the terminal 2 via wireless communication.

### UpLink

The radio unit 3 receives data from the terminal 2 via wireless communication.

The interface 71 of the control target server 70 receives data from the radio unit 3 via the network 16, and acquires the data via the NIC 51 and the driver 61 (in FIG. 2B, the PMD 81 of the DPDK 80) of the OS 60. The interface 71 performs protocol processing on the acquired data packet and passes the data to the processor 72.

The processor 72 generates data in a format interpretable by the aggregation device 30 and passes the data to the interface 71. The interface 71 passes data to the aggregation device 30 via the driver 61 of the OS 60 and the NIC 52.

The aggregation device 30 receives data from the control target server 70 via the network 12.

In the control target server 70, when the processing as described above is performed, the CPU 53 basically performs arithmetic processing. However, some processing may be performed by other arithmetic devices such as GPUs or FPGAs.

A plurality of CPUs 53 may be mounted on the control target server 70. In addition, the CPU 53 may be a multi-core processor equipped with a plurality of “processor cores”, each of which operates independently like a single processor.

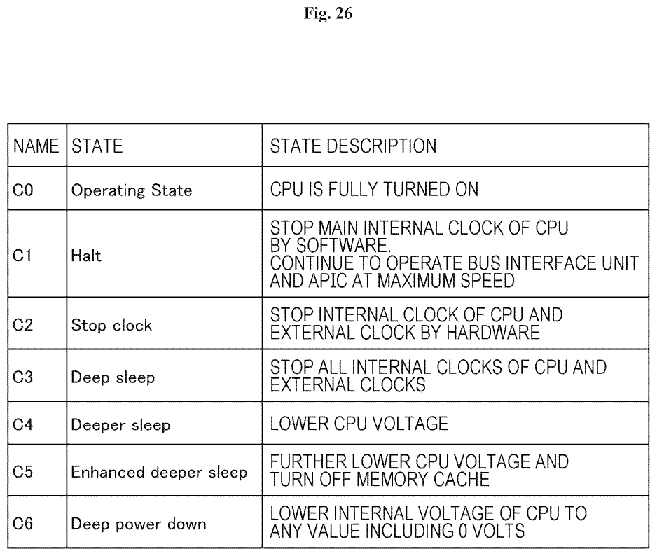

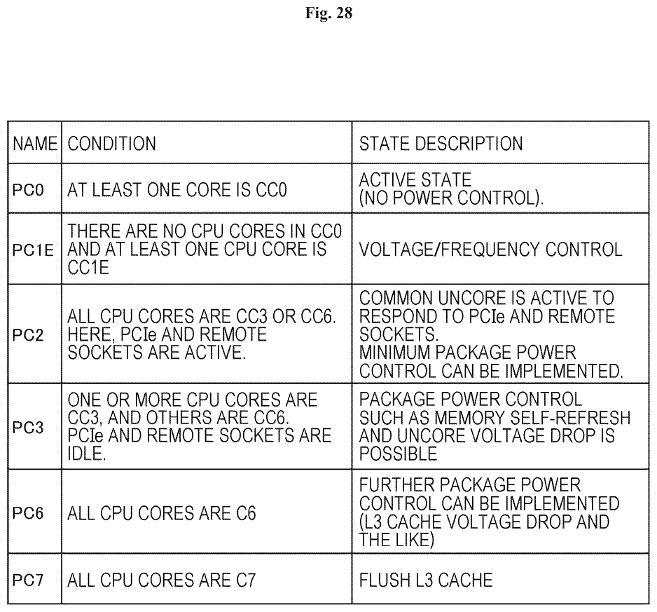

In the present embodiment, a multi-core processor is assumed, and a setting change of the power mode CC-state (FIG. 27) of the core will be described. However, in the control target server 70 equipped with a plurality of single-core processors, it can be interpreted as a setting change of the C-state (FIG. 26). In addition, it can be interpreted as a setting change of the P-state (FIG. 28) or a setting change of the power capping function.

### [Operation of Active Core Number Controller 100 (Power Saving Function Control Device)]

Next, the operation of the active core number controller 100 will be described.

In the rule accumulator 110 of the active core number controller 100 of the control target server 70 illustrated in FIGS. 2A and 2B, rules adapted to the corresponding control target server 70 are accumulated.

FIG. 3 is a diagram showing, in the form of a table, an example of rules accumulated in the rule accumulator 110.

The rule table shown in FIG. 3 is updated according to the setting item (rule reflection interval: 60 sec/traffic volume evaluation period: 60 sec), and stores the required number of CPU cores for the traffic (Mbps). For example, in a case where the traffic (traffic volume) is 0 to 1999 (Mbps), the required number of CPU cores is 3.

The setting items of the rule table will be described.

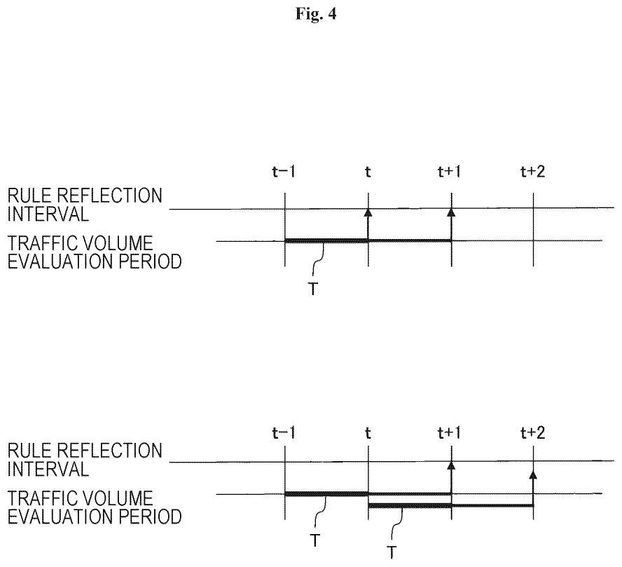

FIG. 4 is a diagram illustrating setting items of the rule table shown in FIG. 3.

The upper diagram of FIG. 4 shows a rule reflection interval t and a traffic volume evaluation period T which are table update intervals. The rule reflection interval t and the traffic volume evaluation period T are, for example, the same 60 sec, but in T, t−1, which is the first period before t, is set as a starting point, and up to t+1, which is the first period after t, is set as the traffic volume evaluation period.

The lower diagram of FIG. 4 shows a next traffic volume evaluation period T, and in the next traffic volume evaluation period T, tis set as a starting point, and up to t+2, which is the second period after t, is set as the traffic volume evaluation period. That is, the traffic volume evaluation period T is determined for each rule reflection interval t so that the previous traffic volume evaluation period T overlaps with the current traffic volume evaluation period T by half. This is to suppress abrupt state changes when calculating the rate of change in traffic volume.

Returning to FIGS. 2A and 2B, the rule accumulator 110 accumulates rules (FIG. 3) adapted to the corresponding control target server 70.

Methods for accumulating the rules include a method in which an operator individually stores the rules in the control target server 70, and a method in which the control device communicator 74 acquires the rules from the rule storage 210 of the control device 20 and stores the rules in the rule accumulator 110 of the active core number controller 100 of the control target server 70.

The rule reflector 120 controls the CC-state via the CC-state controller 130 in accordance with the rules (FIG. 3) stored in the rule accumulator 110.

As an example of the rule, although a rule (FIG. 3) in which the required number of CPU cores according to the traffic volume is described is described, different rules may be assumed in a case where the power suppression is performed by a method other than the CC-state control.

The rule reflector 120 performs rule reflection according to the rule reflection interval (FIG. 4) stored in the setting of the rule accumulator 110.

The rule reflector 120 obtains the average traffic volume for the stored traffic volume evaluation period in the setting item of the rule accumulator 110 immediately before the reflection trigger. The rule reflector 120 obtains the required number of CPU cores according to the traffic in the rule to which the average traffic volume applies.

When the difference between the number of CPU cores included in the control target server 70 and the required number of CPU cores is a positive value, the rule reflector 120 sets a CC-state other than C0 (for example, CC1) illustrated in FIG. 26 to the number of CPU cores having the difference in order from a core with a small usage rate of the CPU core.

Thereafter, the rule reflector 120 waits for the rule reflection interval to elapse, obtains the number of CPU cores for setting the CC-state according to the rule and the setting item related to the rule, and sets the CC-state other than C0.

The rule reflector 120 repeats the above-described operations.

Here, the control device communicator 74 of the control target server 70 of the plurality of base stations 10 acquires the rules from the rule storage 210 of the control device 20. The control device communicator 74 acquires the rules from the rule storage 210 of the control device 20 and stores the rules in the rule accumulator 110 of the active core number controller 100 of the control target server 70. This allows a plurality of control target servers 70 connected to the control device 20 to reflect the rules.

### Second Embodiment

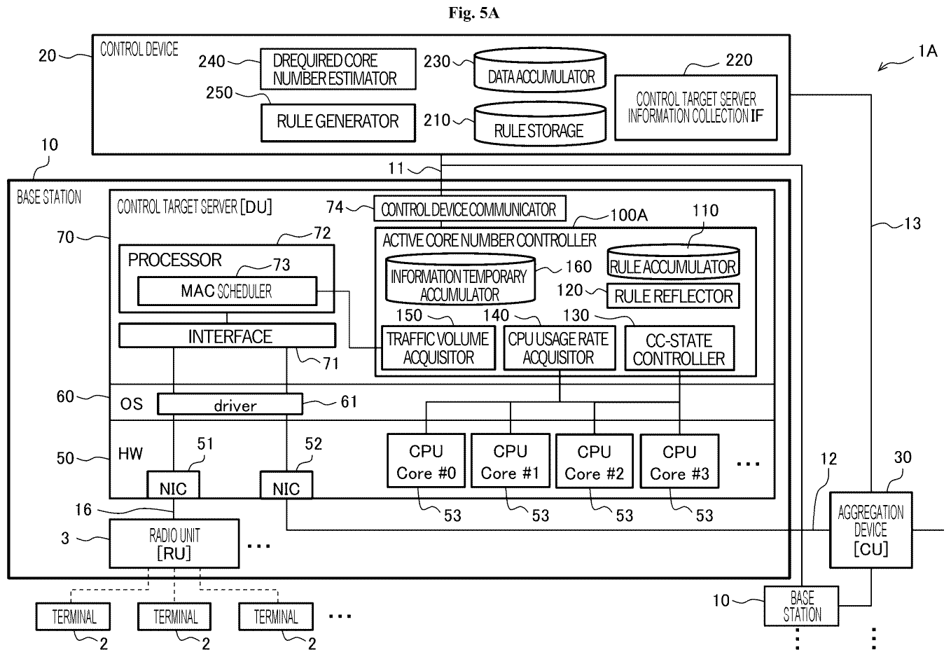

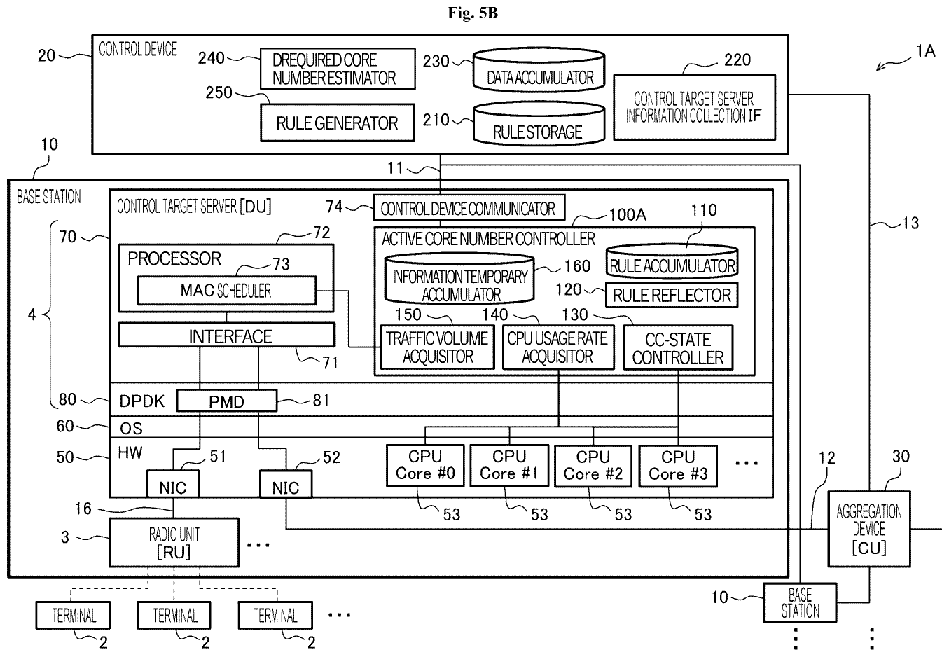

FIG. 5A is a configuration diagram of a base station including a control target server having a power saving function control device according to a second embodiment of the present invention, a control device, an aggregation device, and a terminal. The same components as those in FIG. 2A are denoted by the same reference numerals, and the description of the overlapping parts will be omitted. FIG. 5B is a configuration diagram of the base station in a case where the control target server is arranged in a user space, the control device, the aggregation device, and the terminal. The same components as those in FIG. 2B are denoted by the same reference numerals, and the description of the overlapping parts will be omitted.

As illustrated in FIGS. 5A and 5B, a wireless system 1A includes a base station 10, a control device 20, an aggregation device 30, and a terminal 2.

A control target server 70 of the base station 10 includes an interface 71, a processor 72 having a MAC scheduler 73, a control device communicator 74, and an active core number controller 100A (power saving function control device).

The active core number controller 100A includes a CPU usage rate acquisitor 140, a traffic volume acquisitor 150, and an information temporary accumulator 160 in addition to the components of the active core number controller 100 in FIG. 2.

The CPU usage rate acquisitor 140 acquires the usage rates of all CPU cores mounted on the control target server 70. The usage rate of the CPU core can be acquired using a function (for example, a vmstat command, a TOP command, or the like of Linux (registered trademark)) of an OS 60.

The traffic volume acquisitor 150 distinguishes between UpLink and DownLink and collects the amount of passing data according to a predefined setting determined in advance.

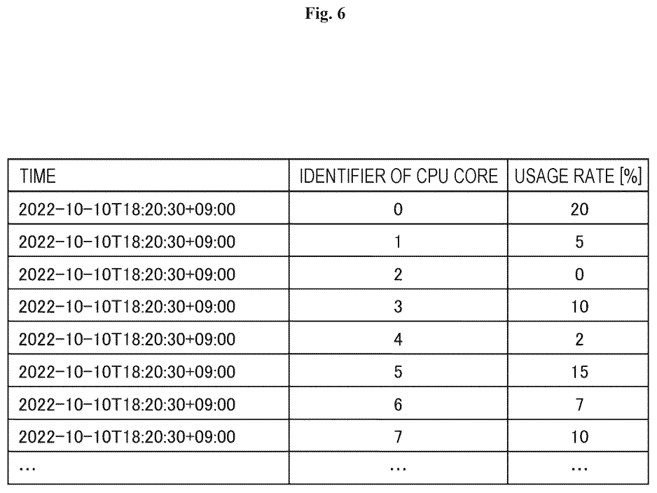

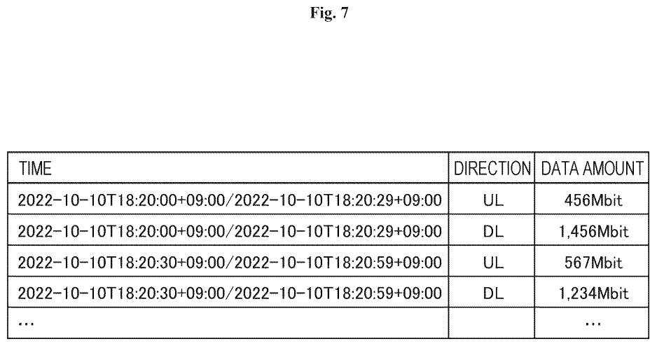

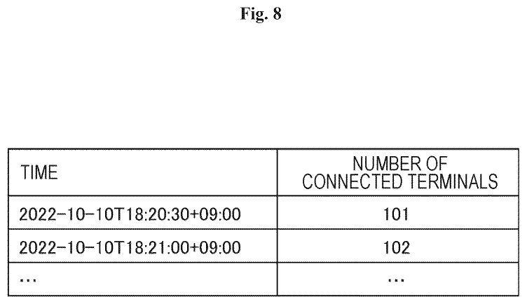

The information temporary accumulator 160 holds the acquired value of the usage rate of the CPU core, the acquired identifier of the CPU core, and the acquired time as CPU usage rate information (FIG. 6). In addition, the information temporary accumulator 160 collects the amount of data that has passed together with the data direction and the acquisition time (FIG. 7). In addition, the information temporary accumulator 160 collects the number of connected terminals (the number of terminals 2 being connected) acquired periodically (FIG. 8).

The control device 20 includes a control target server information collection IF 220, a data accumulator 230, a required core number estimator 240, and a rule generator 250 in addition to the components of the control device 20 in FIGS. 2A and 2B.

The control target server information collection IF 220 collects information on other control devices 20 via the aggregation device 30.

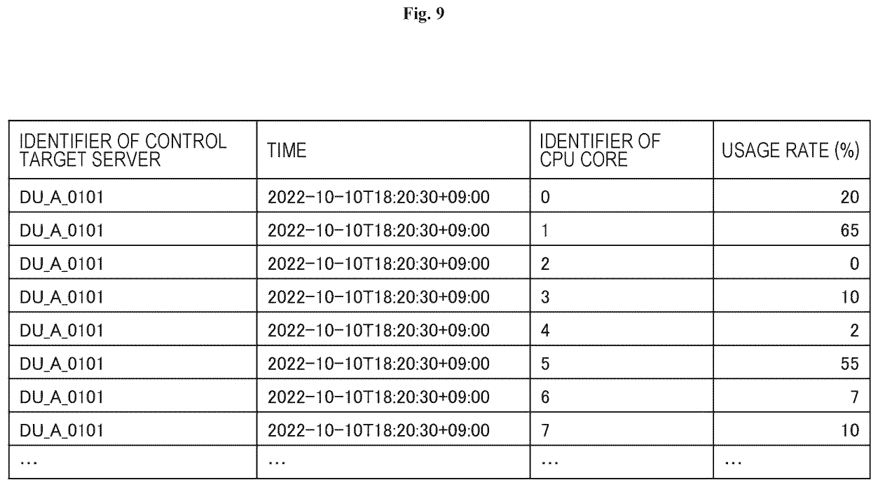

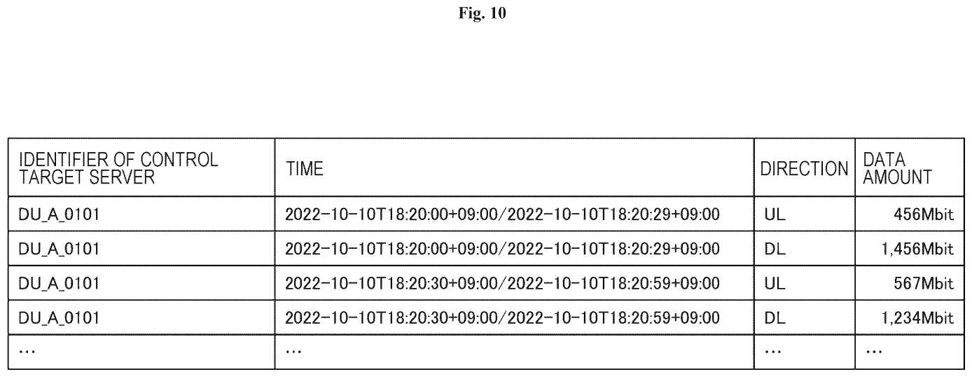

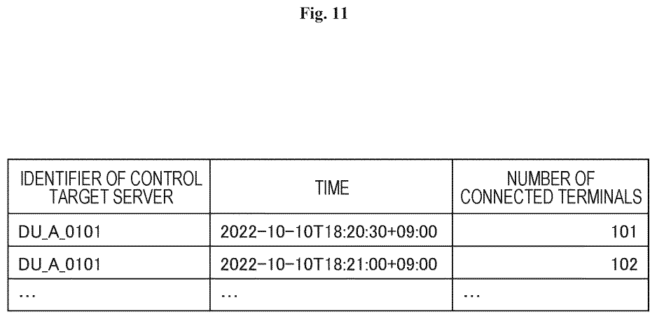

The data accumulator 230 accumulates information on the CPU core usage rate (FIG. 9), the data amount (FIG. 10), and the number of connected terminals (FIG. 11) of each control target server 70.

The required core number estimator 240 acquires desired data from the data accumulator 230, estimates the required number of CPU cores according to various conditions, and passes a combination of the condition and the required number of CPU cores, which is an estimation result, to the rule generator 250.

The rule generator 250 updates the rule stored in the rule storage 210 on the basis of the information accumulated in the data accumulator 230.

Hereinafter, the operation of the wireless system 1A configured as described above will be described.

Since the overall operation of the wireless system 1A is similar to that illustrated in FIGS. 2A and 2B, the description thereof will be omitted, and the operations of the active core number controller 100A and the control device 20 will be described.

### [Operation of Control Target Server 70]

First, an information collection flow of the control target server 70 will be described.

In the control target server 70, when each functional unit is started up, a predetermined setting that has been prepared in advance is read.

The CPU usage rate acquisitor 140 of the active core number controller 100 of the control target server 70 acquires the usage rates of all CPU cores mounted on the control target server 70. The CPU usage rate acquisitor 140 can acquire the usage rates of all CPU cores by using the function of the OS 60.

The above data is acquired simultaneously for all CPU cores, and is acquired periodically according to the settings. The acquired value of the usage rate of the CPU core is held in the information temporary accumulator 160 together with the identifier of the CPU core and the acquisition time as CPU usage rate information.

The traffic volume acquisitor 150 of the active core number controller 100 of the control target server 70 distinguishes between UpLink and DownLink and collects the amount of data passing through the NICs 51 and 52 or the interface 71 according to a predefined setting determined in advance. The amount of collected data is held in the information temporary accumulator 160 together with the data direction and acquisition time.

The MAC scheduler 73 of the processor 72 of the control target server 70 holds the number of terminals 2 being connected via the radio unit 3.

The active core number controller 100A of the control target server 70, as a connected terminal number collection function, periodically acquires the number of connected terminals (the number of terminals 2 being connected) from the MAC scheduler 73 according to a predetermined setting. The acquired number of connected terminals is held in the information temporary accumulator 160 together with the acquisition time.

The control device communicator 74 of the active core number controller 100A of the control target server 70 transmits the information on the CPU core usage rate, the data amount, and the number of connected terminals held in the information temporary accumulator 160 to a uniform resource locator (URL) of the corresponding control target server information collection IF 220 according to a preset control device data transmission interval.

In the present embodiment, the information on the CPU core usage rate, the data amount, and the number of connected terminals is transmitted by hyper text transfer protocol (HTTP), but may be transmitted by hypertext transfer protocol secure (HTTPS) or may be transmitted by another protocol.

The control target server information collection IF 220 collects control target server information and accumulates the data in the data accumulator 230.

By each control target server 70 executing the above operation, information such as the CPU core usage rate, the data amount, and the number of connected terminals in each control target server 70 can be collected in the data accumulator 230 of the control device 20.

### [Accumulated Information in Information Temporary Accumulator 160 (Part 1)]

FIGS. 6 to 8 are diagrams showing, in the form of tables, respective pieces of information temporarily accumulated in the information temporary accumulator 160. The conditions for collecting information are as follows.
“Interval for acquiring CPU core usage rate”: “30 sec”
“Control device data transmission interval”: “3 min”
“Interval for acquiring number of connected terminals”: “30 sec”
“Control target server information collection IF”:“http://192.168.5.100/postif/”

FIG. 6 is a diagram showing just-collected information temporarily accumulated in the information temporary accumulator 160.

The information temporary accumulator 160 accumulates the identifier of the CPU core and the usage rate (%) thereof for each acquisition time.

FIG. 7 is a diagram showing the amount of passing data temporarily accumulated in the information temporary accumulator 160.

The traffic volume acquisitor 150 distinguishes between UpLink and DownLink and collects the amount of passing data according to a predefined setting determined in advance.

The information temporary accumulator 160 accumulates the UpLink and DownLink directions and the amount of data collected by the traffic volume acquisitor 150 for each acquisition time.

FIG. 8 is a diagram showing information on the number of connected terminals (the number of terminals 2 being connected) temporarily accumulated in the information temporary accumulator 160.

The number of connected terminals is accumulated in the information temporary accumulator 160 for each acquisition time.

[Accumulated Information in Data accumulator 230 (Part 2)]

FIGS. 9 to 11 are diagrams showing, in the form of tables, respective pieces of information accumulated in the data accumulator 230 of the control device 20.

FIG. 9 is a diagram showing information on the usage rate of the CPU core accumulated in the data accumulator 230.

The data accumulator 230 accumulates the acquisition time, the identifier of the CPU core, and the usage rate (%) of the CPU core for each identifier of the control target server.

FIG. 10 is a diagram showing the amount of passing data accumulated in the data accumulator 230.

The data accumulator 230 accumulates the acquisition time, the UpLink and DownLink directions, and the data amount for each identifier of the control target server.

FIG. 11 is a diagram showing information on the number of connected terminals (the number of terminals 2 being connected) accumulated in the data accumulator 230.

The data accumulator 230 accumulates the acquisition time and the number of connected terminals for each identifier of the control target server.

### [Operation of Control Device 20]

The required core number estimator 240 of the control device 20 illustrated in FIG. 5 acquires desired data from the data accumulator 230, estimates the required number of CPU cores according to various conditions, and passes a combination of the condition and the required number of CPU cores, which is an estimation result, to the rule generator 250.

### <Method for Estimating Required Number of CPU Cores>

An example of a method in which the required core number estimator 240 estimates the required number of CPU cores according to various conditions will be described.
1. An example of estimating the number of CPU cores that should be kept in operation from the traffic and the CPU usage rate of each control target server 70

The following is acquired from the information in the table shown in FIG. 9 and the table shown in FIG. 10 in the data accumulator 230 of the control device 20.
Data capacity of UL at a certain time (t−1→t): 0456 Mb
Data capacity of DL at a certain time (t−1→t): 1456 Mb

Further, the following is acquired.
Number of cores that are equal to or greater than a threshold value (e.g., 50%) in the CPU core usage rate at time t: 2
Sum of the usage rates of the cores that are less than a threshold value (e.g., 50%) in the CPU core usage rate at time t: 49%

Accordingly, the required core number estimator 240 assumes that the number of cores required to keep the CPU core usage rate below the threshold value (e.g., 50%) is 49%/50%<1 core.

As a result, the traffic volume: 1,912 Mb and the number of CPU cores that should be kept in operation: 3 are obtained as the estimation result.
2. An example of estimating the number of CPU cores that should be kept in operation from the number of terminals [UE] 2 being connected and the CPU usage rate of each control target server 70

The following is acquired from the information in the table shown in FIG. 9 and the table shown in FIG. 11 in the data accumulator 230 of the control device 20.

Number of connected terminals at a certain time (t): 101 Further, the following is acquired.
Number of cores that are equal to or greater than a threshold value (e.g., 50%) in the CPU core usage rate at time t: 2
Sum of the usage rates of the cores that are less than a threshold value (e.g., 50%) in the CPU core usage rate at time t: 49%

Accordingly, the required core number estimator 240 assumes that the number of cores required to keep the CPU core usage rate below the threshold value (e.g., 50%) is 49%/50%<1 core.

As a result, the number of connected terminals: 101 and the number of CPU cores that should be kept in operation: 3 are obtained as the estimation result.
3. An example of estimating the number of CPU cores that should be kept in operation from the traffic, the number of connected terminals, and the CPU usage rate of each control target server 70

The following is acquired from the table shown in FIG. 9, the table shown in FIG. 10, and the table shown in FIG. 11 in the data accumulator 230 of the control device 20.
Data capacity of UL at a certain time (t−1→t): 0456 Mb
Data capacity of DL at a certain time (t−1→t): 1456 Mb
Number of connected terminals [UE] 2 at a certain time (t): 101

Further, the following is acquired.

Number of cores that are equal to or greater than a threshold value (e.g., 50%) in the CPU core usage rate at time t: 2

Sum of the usage rates of the cores that are less than a threshold value (e.g., 50%) in the CPU core usage rate at time t: 49%

Accordingly, the required core number estimator 240 assumes that the number of cores required to keep the CPU core usage rate below the threshold value (e.g., 50%) is 49%/50%<1 core.

As a result, the traffic volume: 1,912 Mb, the number of connected terminals [UE] 2: 101 and the number of CPU cores that should be kept in operation: are obtained as the estimation result.

The method for estimating the required number of CPU cores according to various conditions by the required core number estimator 240 has been described above.

### <Rule Generation Method>

The rule generator 250 of the control device 20 illustrated in FIG. 5 receives a combination of a condition and the required number of CPU cores, and updates the rules held in the rule storage 210.

Regarding rules, there are a method of generating a rule on the basis of only information on a corresponding control target server 70 and reflecting the rule in the control target server 70, a method of generating a rule on the basis of only information on a corresponding control target server 70 and reflecting the rule in a plurality of control target servers 70 connected to the control device 20, and a method of generating a rule on the basis of information on a plurality of control target servers 70 connected to the control device 20 and reflecting the rule in the plurality of control target servers 70 connected to the control device 20.

When reflecting the rules in the plurality of control target servers 70, as in the first embodiment, this can be achieved by the control device communicator 74 of the control target servers 70 of the plurality of base stations 10 acquiring the rules from the rule storage 210 of the control device 20.

The movement in which the rule reflector 120 operates on the basis of the rule stored in the rule accumulator 110 of the control target server 70 is similar to that in the first embodiment.

First, an example of generating a rule on the basis of information on a plurality of control target servers 70 will be described.

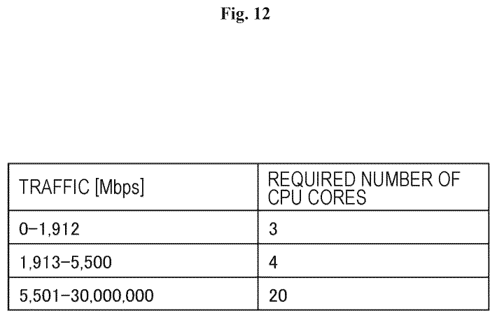

FIG. 12 is an explanatory diagram for generating a rule on the basis of information on a plurality of control target servers 70.

In FIG. 12, the following rules are generated: maximum traffic without processing delay: 30,000,000 Mbps; number of cores installed in the control target server 70: 20. Hereinafter, generation of rules in FIG. 12 will be described.

The required core number estimator 240 of the control device 20 acquires data from the table of FIG. 9 and the table of FIG. 10 in the data accumulator 230 of the control device 20 as follows.
Data capacity of UL of DU_A_0101 at a certain time (t−1→t): 0456 Mb
Data capacity of DL of DU_A_0101 at a certain time (t−1→t): 1456 Mb
Data capacity of UL of DU_A_0102 at a certain time (t−1→t): 1500 Mb
Data capacity of DL of DU_A_0102 at a certain time (t−1→t): 4000 Mb

Further, the following is acquired.
Number of cores that are equal to or greater than a threshold value (e.g., 50%) in the CPU core usage rate of DU_A_0101 at time t: 2
Sum of the usage rates of the cores that are less than a threshold value (e.g., 50%) in the CPU core usage rate of DU_A_0101 at time t: 49%

Accordingly, the required core number estimator 240 assumes that the number of cores required to keep the CPU core usage rate below the threshold value (e.g., 50%) is 49%/50%<1 core.

As a result, the traffic volume: 1,912 Mb and the number of CPU cores that should be kept in operation: 3
are acquired.

Similarly, the following is acquired.

Number of cores that are equal to or greater than a threshold value (e.g., 50%) in the CPU core usage rate of DU_A_0102 at time t: 2

Sum of the usage rates of the cores that are less than a threshold value (e.g., 50%) in the CPU core usage rate of DU_A_0102 at time t: 57%

Thereby, the required core number estimator 240 assumes that the number of cores required to keep the CPU core usage rate below the threshold value (e.g., 50%) is 57%/50%<2 cores.

As a result, the traffic volume: 5,500 Mb and the number of CPU cores that should be kept in operation: 4
are acquired.

Next, an example of a method in which the rule generator 250 of the control device 20 generates a rule from an estimation result will be described.
1. An example of estimating the number of CPU cores that should be kept in operation from the traffic and the CPU usage rate of each control target server 70

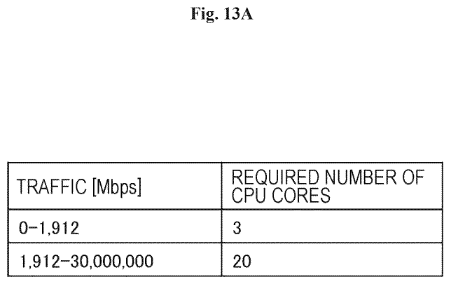

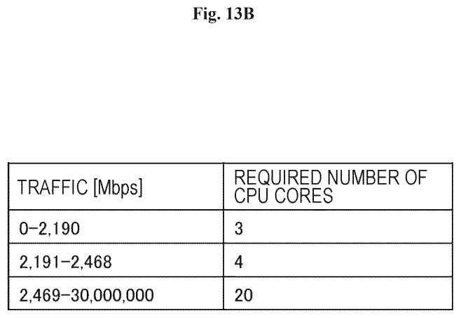

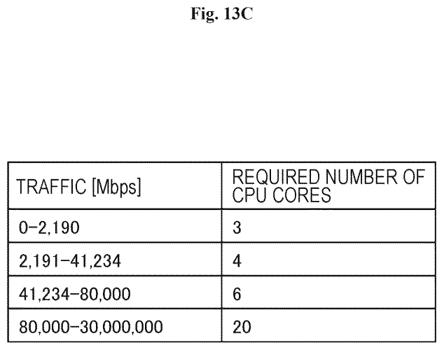

FIGS. 13A to 13C are explanatory diagram for estimating the number of CPU cores that should be kept in operation from the traffic and the CPU usage rate of each control target server 70.

The rule generator 250 updates the rules using a plurality of estimation results (combinations of conditions and the required number of CPU cores).

That is, as shown in FIG. 13A, the rule generator 250 creates a rule using the maximum traffic without processing delay: 30,000,000 Mbps and the number of cores installed in the control target server 70: 20 (FIG. 13A is the first rule).

In a case where the following is acquired at the next update time, the rule generator 250 updates the rules as shown in FIG. 13B.
Traffic volume: 1,912 Mb Required number of CPU cores: 3
Traffic volume: 2,468 Mb Required number of CPU cores: 4

Note that the traffic 2,191 shown in FIG. 13B is based on the following.

$$2 \; 468 - 1912 = 556 , 1912 + 556 / 2 = 2190$$

Furthermore, in a case where the following is acquired at the next update time, the rule generator 250 updates the rules as shown in FIG. 13C.
Traffic volume: 1,912 Mb Required number of CPU cores: 3
Traffic volume: 2,468 Mb Required number of CPU cores: 4
Traffic volume: 80,000 Mb Required number of CPU cores: 6

Note that the traffic 2,191 shown in FIG. 13C is based on the following.

$$80 , 000 - 2 , 468 = 556 , 2468 + 77532 / 2 = 2190$$

As shown in FIGS. 13A to 13C, the rule generator 250 updates the rules using a plurality of estimation results (combinations of conditions and the required number of CPU cores), thereby generating rules in which the required number of CPU cores is subdivided for each traffic within the range of the required number of CPU cores 20.
2. An example of estimating the number of CPU cores that should be kept in operation from the CPU usage rate and the number of terminals being connected to each control target server 70

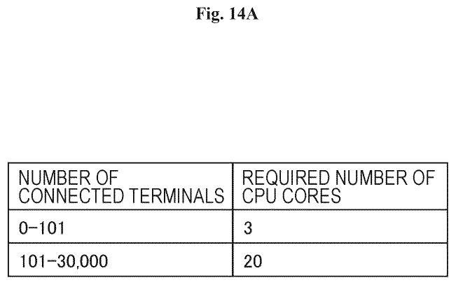

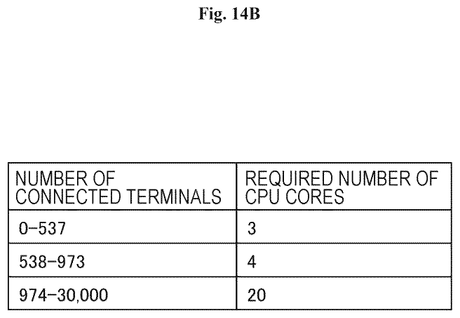

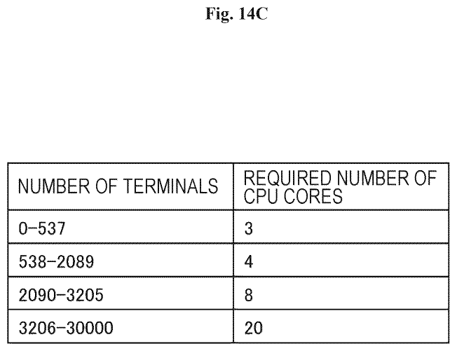

FIGS. 14A to 14C are explanatory diagram for estimating the number of CPU cores that should be kept in operation from the CPU usage rate and the number of terminals being connected to each control target server 70.

The rule generator 250 updates the rules using the number of terminals being connected and the CPU usage rate. That is, as shown in FIG. 14A, the rule generator 250 creates a rule using the number of connected terminals: 101 and the required number of CPU cores: 3 (FIG. 14A is the first rule).

In a case where the following is acquired at the next update time, the rule generator 250 updates the rules as shown in FIG. 14B.
Number of connected terminals: 101 Required number of CPU cores: 3
Number of connected terminals: 973 Required number of CPU cores: 4

Note that the number of connected terminals 537 shown in FIG. 14B is based on the following.

$$973 - 101 = 872 , 101 + 872 / 2 = 537$$

Further, in a case where the following is acquired at the next update time, the rule generator 250 updates the rules as shown in FIG. 14C.
Number of connected terminals: 101 Required number of CPU cores: 3
Number of connected terminals: 970 Required number of CPU cores: 4
Number of connected terminals: 3205 Required number of CPU cores: 8

Note that the number of connected terminals 2089 shown in FIG. 14C is based on the following.

$$3 \; 205 - 973 = 2232 , 973 + 2 \; 232 / 2 = 2089$$

The rule generator 250 updates the rules using the number of terminals being connected shown in FIGS. 14A to 14C and the CPU usage rate acquired by the CPU usage rate acquisitor 140 in FIG. 5 (more specifically, the CPU usage rate is acquired by the CPU usage rate acquisitor 140, collected by the control target server information collection IF 220, and accumulated in the data accumulator 230), thereby generating rules in which the required number of CPU cores is subdivided for each number of terminals within the range of the required number of CPU cores 20.
3. An example of estimating the number of CPU cores that should be kept in operation from the traffic, the number of connected terminals, and the CPU usage rate of each control target server 70

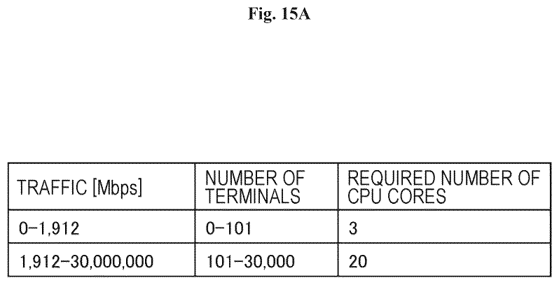

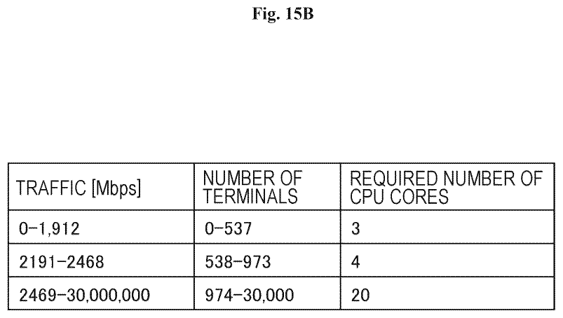

FIGS. 15A and 15B are explanatory diagram for estimating the number of CPU cores that should be kept in operation from the traffic, the number of connected terminals, and the CPU usage rate of each control target server 70.

The rule generator 250 updates the rules using the traffic shown in FIGS. 15A to 15B, the number of terminals being connected, and the CPU usage rate acquired by the CPU usage rate acquisitor 140 in FIG. 5. That is, as shown in FIG. 15A, the rule generator 250 creates a rule using the traffic volume: 1,912 Mb, the number of connected terminals: 101, and the required number of CPU cores: 3 (FIG. 15A is the first rule).

In a case where the following is acquired at the next update time, the rule generator 250 updates the rules as shown in FIG. 15B.
Traffic volume: 1,912 Mb Number of connected terminals: 101 Required number of CPU cores: 3
Traffic volume: 2,468 Mb Number of connected terminals: 973 Required number of CPU cores: 4

The rule generator 250 updates the rules using the traffic shown in FIGS. 15A to 15B, the number of terminals being connected, and the CPU usage rate acquired by the CPU usage rate acquisitor 140 in FIG. 5, thereby generating rules in which the required number of CPU cores is subdivided for each traffic and the number of terminals within the range of the required number of CPU cores 20.

### Example of Holding in Data Accumulator 230

An example of holding in the data accumulator 230 will be described.
1. An example of estimating the number of CPU cores that should be kept in operation from the traffic and the CPU usage rate of each control target server 70

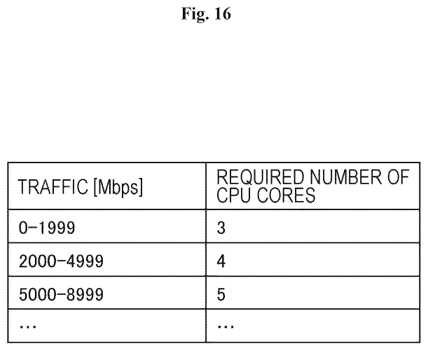

FIG. 16 is a diagram showing, in the form of a table, an example in which the number of CPU cores that should be kept in operation is estimated from traffic and a CPU usage rate of each control target server 70, and is held in the data accumulator 230. The setting items are rule reflection interval: 60 sec, and traffic volume evaluation period: 60 sec.
2. An example of estimating the number of CPU cores that should be kept in operation from the number of terminals and the CPU usage rate of each control target server 70

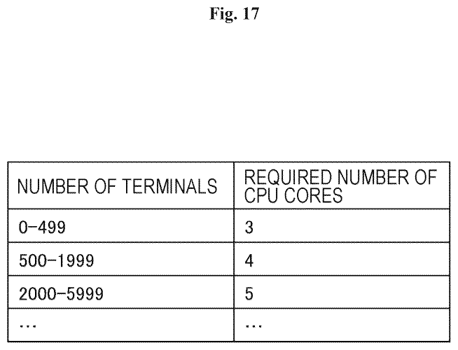

FIG. 17 is a diagram showing, in the form of a table, an example in which the number of CPU cores that should be kept in operation is estimated from the number of terminals and a CPU usage rate of each control target server 70, and is held in the data accumulator 230. The setting item is rule reflection interval: 60 sec.
3. An example of estimating the number of CPU cores that should be kept in operation from the traffic, the number of connected terminals, and the CPU usage rate of each control target server 70

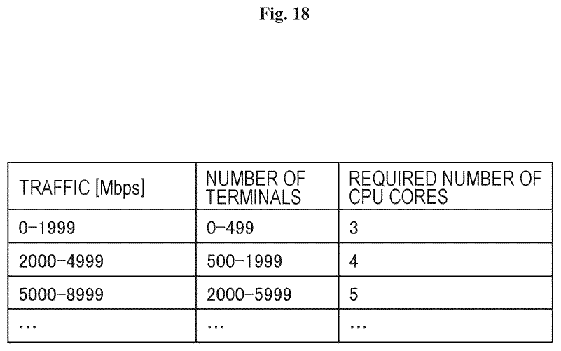

FIG. 18 is a diagram showing, in the form of a table, an example in which the number of CPU cores that should be kept in operation is estimated from traffic, the number of connected terminals, and a CPU usage rate of each control target server 70, and is held in the data accumulator 230. The setting items are rule reflection interval: 60 sec, and traffic volume evaluation period: 60 sec.

### Third Embodiment

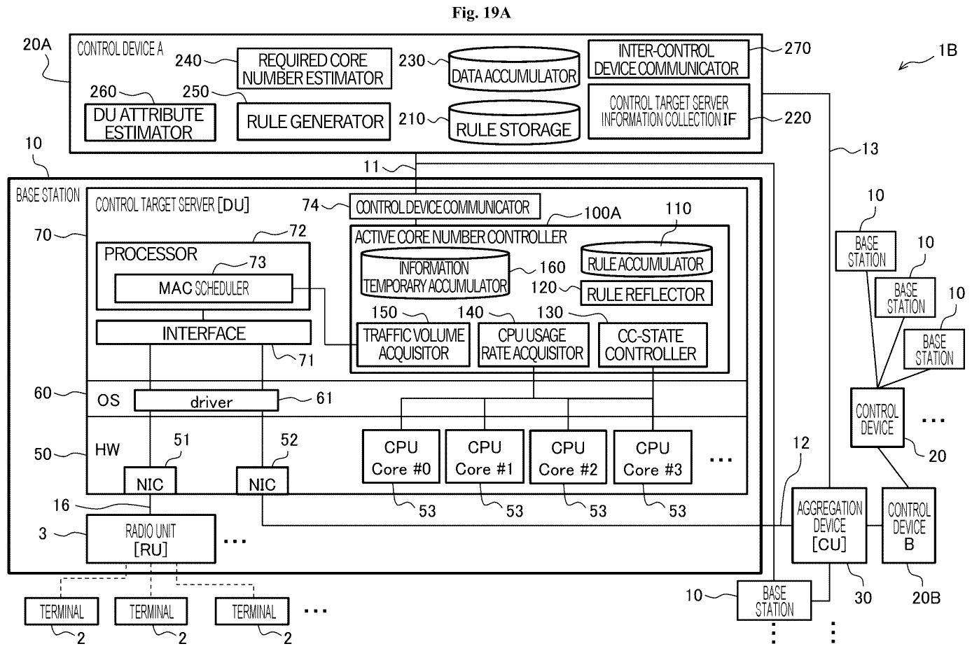

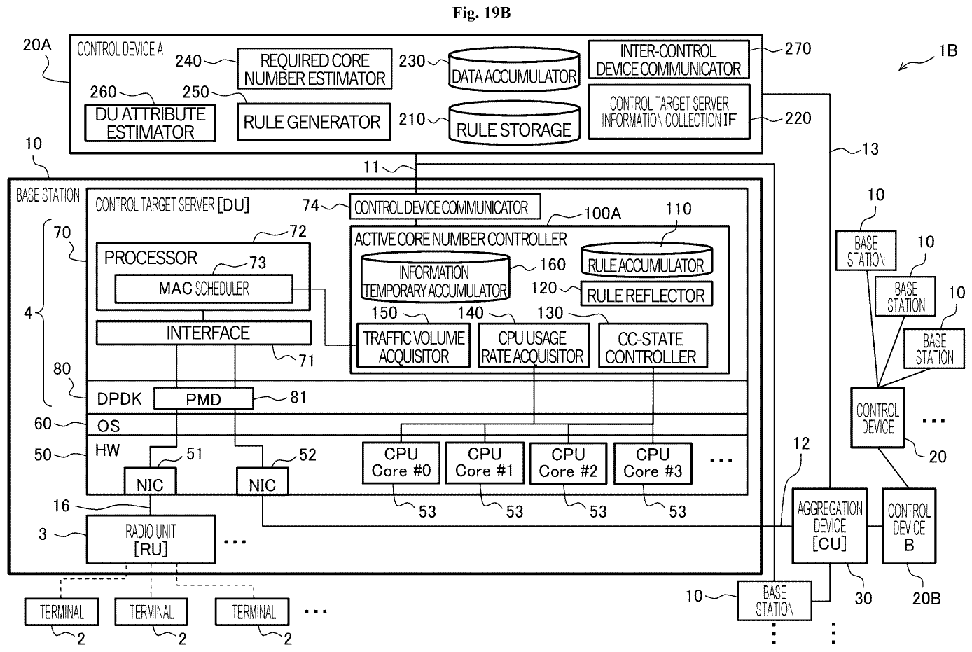

FIG. 19A is a configuration diagram of a base station including a control target server having a power saving function control device according to a third embodiment of the present invention, a control device, an aggregation device, and a terminal. The same components as those in FIG. 5A are denoted by the same reference numerals, and the description of the overlapping parts will be omitted. FIG. 19B is a configuration diagram of the base station in a case where the control target server is arranged in a user space, the control device, the aggregation device, and the terminal. The same components as those in FIG. 5B are denoted by the same reference numerals, and the description of the overlapping parts will be omitted.

The third embodiment is an example in which rules are transferred between control devices 20.

As illustrated in FIGS. 19A and 19B, a wireless system 1B includes a base station 10, a control device 20, a control device 20A, a control device 20B, an aggregation device 30, and a terminal 2.

The control device 20A and the control device 20B have the same configuration as the control device 20 in FIG. 5 except that an inter-control device communicator 270 is provided.

The inter-control device communicator 270 of the control device 20B transmits a rule acquisition request to an access destination to the inter-control device communicator 270 of the control device 20A at every rule acquisition interval time.

The inter-control device communicator 270 of the control device 20A acquires the rule from the rule storage 210, and transmits the rule to the inter-control device communicator 270 of the control device 20B as a response to the request.

The inter-control device communicator 270 of the control device 20B that has acquired the rule stores the rule in the rule storage 210 of the control device 20B.

The inter-control device communicator 270 of the control device 20A may have a function of checking whether or not the rule transmitted as the previous response has been updated.

As a result of the check, in a case where there is no update, the notice that there is no update may be transmitted as a response. In addition, the inter-control device communicator 270 of the control device 20B that has acquired the notice that there is no update may not perform anything in particular.

As in the first embodiment, the rule storage 210 of the control device 20B transmits the rules to the control target server 70 on the basis of the acquisition request from the control device communicator 74 of the control target server 70, and stores the rules in the rule accumulator 110 of the active core number controller 100 of the control target server 70.

The inter-control device communicator may be arranged not only in the control device 20 but also in the rule storage 210 and in a device having a communication function between the control devices 20 (for example, an operation device or a rule management device). In addition, a device including the rule storage 210 and a device having a communication function between the control devices 20 may simply be connected via a network.

### Fourth Embodiment

In a fourth embodiment, the rule accumulator 110 of the active core number controller 100 of the control target server 70 of the base station 10 in FIGS. 2 and 5 holds the attribute of the control target server 70.

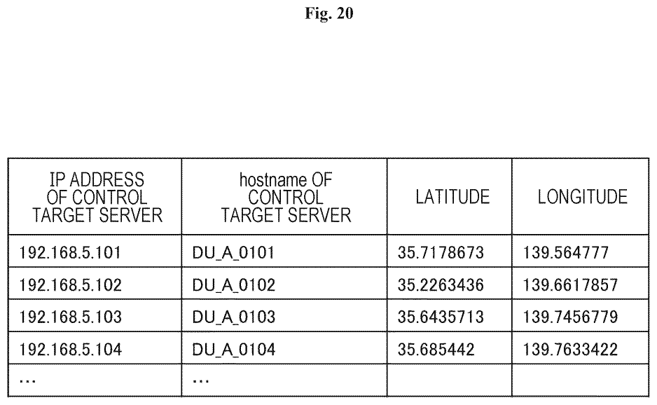

FIG. 20 is a diagram showing information on an IP address of a control target server 70, a hostname of the control target server 70, and latitude and longitude, which are arrangement places of the control target server 70, accumulated in a data accumulator 230.

The data accumulator 230 accumulates information on the IP address of the control target server 70, the hostname of the control target server 70, and the latitude and longitude, which are arrangement places of the control target server 70.

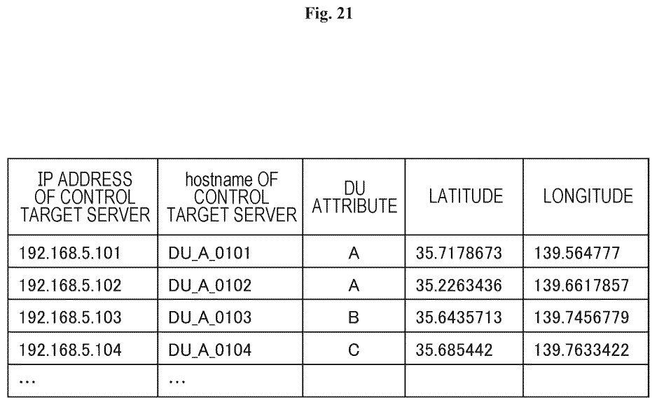

In FIG. 21, attribute information (DU attribute) of the control target server 70 is accumulated in addition to the information on the IP address of the control target server 70, and the hostname, latitude, and longitude of the control target server 70 in FIG. 20.

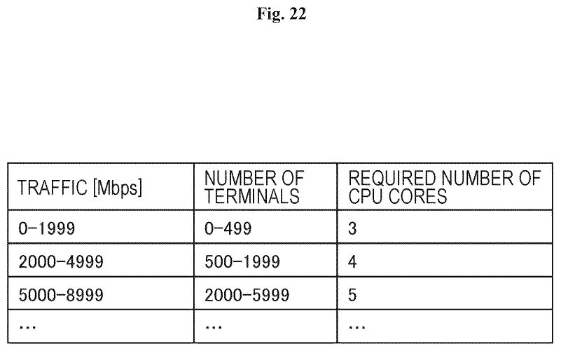

FIG. 22 is a diagram showing, in the form of a table, an example in which the number of CPU cores that should be kept in operation is estimated from traffic, the number of connected terminals, and a CPU usage rate of each control target server 70, and is held in the data accumulator 230. The setting items are rule reflection interval: 60 sec, traffic volume evaluation period: 60 sec, and DU attribute: A. FIG. 22 uses attribute information in addition to the table in FIG. 18.

### <Rule Generation>

Data indicating a correspondence between the control target server 70 and the attribute of the control target server 70 is stored in the data accumulator 230 of the control device 20 illustrated in FIGS. 2A, 2B, 5A, and 5B (FIG. 21).

The rule generator 250 of the control device 20 illustrated in FIGS. 2A, 2B, 5A, and 5B generates rules for the attribute of the control target server 70 on the basis of data of the control target server 70 (or the plurality of control target servers 70) having the same attribute of the control target server 70.

### <Rule Reflection>

The control device 20 illustrated in FIGS. 2 and 5 applies the rule for the attribute of the control target server 70 to the control target server 70 having the same attribute of the control target server 70.

The attribute of the control target server 70 may be determined by the operator or another system, or may also be set in the present system.

### Fifth Embodiment

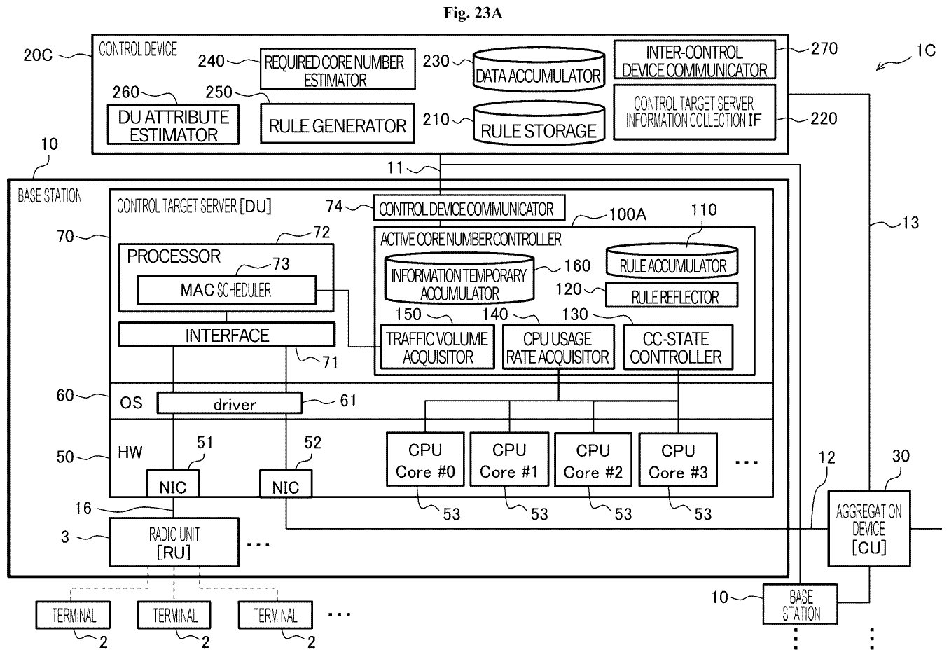

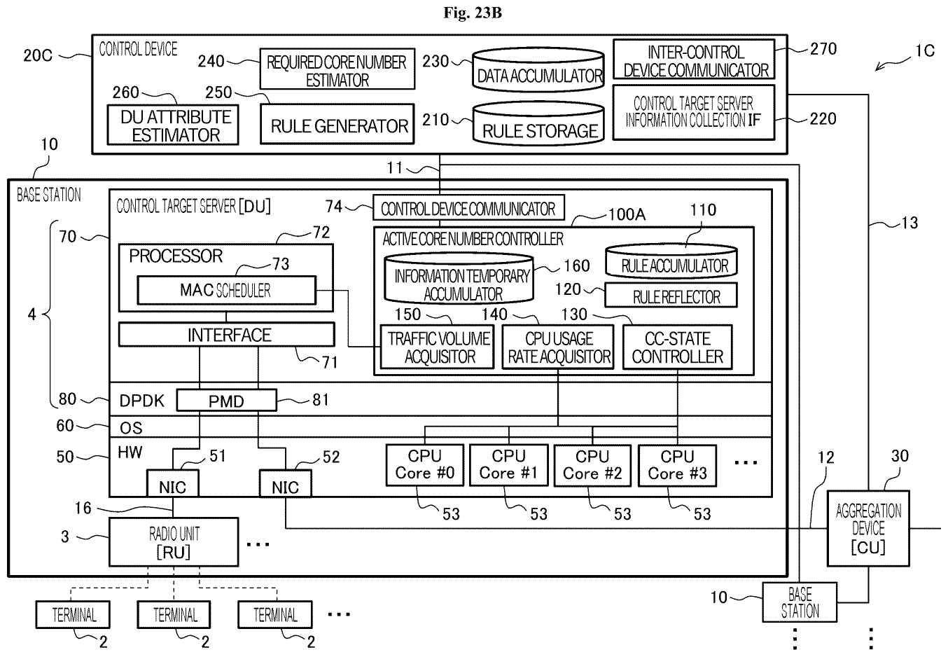

FIG. 23A is a configuration diagram of a base station including a control target server having a power saving function control device according to a fifth embodiment of the present invention, a control device, an aggregation device, and a terminal. The same components as those in FIG. 5A are denoted by the same reference numerals, and the description of the overlapping parts will be omitted. FIG. 23B is a configuration diagram of the base station in a case where the control target server is arranged in a user space, the control device, the aggregation device, and the terminal. The same components as those in FIG. 5B are denoted by the same reference numerals, and the description of the overlapping parts will be omitted.

The fifth embodiment is an example of estimating a DU attribute.

As illustrated in FIGS. 23A and 23B, a wireless system 1C includes a control device 20C, and the control device 20C includes a DU attribute estimator 260.

A rule storage 210 of the control device 20C stores settings related to a DU attribute estimation trigger. For example, the DU attribute estimation time is stored. In addition, numerical values for setting the number of classifications of DU attributes are stored.

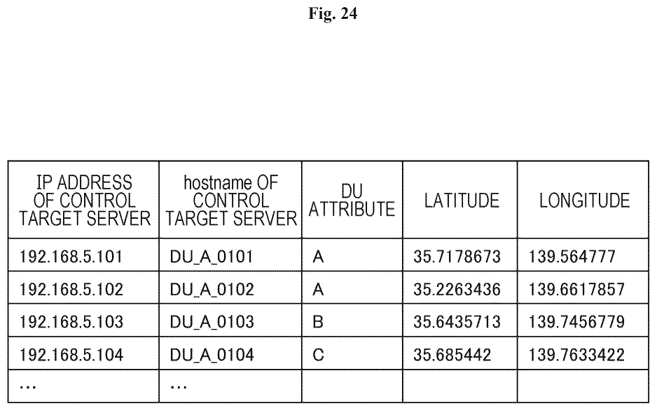

FIG. 24 is a diagram showing, in the form of a table, information on an IP address of a control target server 70, a hostname of the control target server, attribute information (DU attribute) of the control target server, and latitude and longitude, which are arrangement places of the control target server 70, accumulated in a data accumulator 230.

When the DU attribute estimation time arrives, the DU attribute estimator 260 of the control device 20 acquires data from the data accumulator 230 (FIG. 24).

The DU attribute estimator 260 estimates the DU attribute of the acquired data.

For the estimation of DU attributes, DUs having close properties are grouped using clustering which is one of unsupervised machine learning. For example, the k-means method can be used on the basis of the data of each table in FIGS. 6 to 9 using the number of classifications of the DU attribute.

As a result of the clustering, the DU attribute of the control target server 70 can be classified into the number of types for which the number of classifications of the preset DU attribute is set.

Furthermore, in a case where a single DU attribute is linked to the control target server 70, a method for obtaining one type of feature amount from the data of each DU is required. However, in a case where the DU attribute can have a plurality of values, it is not necessary to combine the feature amounts from the data of each DU into one, and for example, the feature amount can be obtained for each data type, and a plurality of types of classification can be performed.

### [Hardware Configuration]

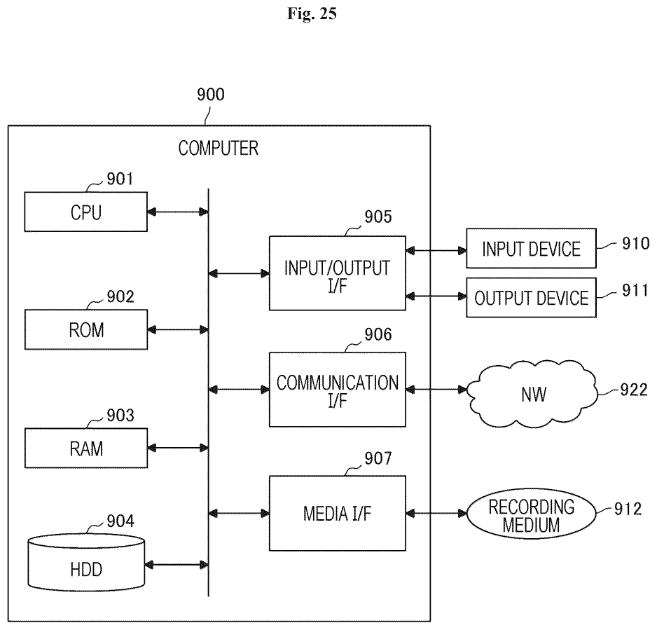

The power saving function control device 100 or 100A (FIGS. 2A, 2B, 5A, and 5B) according to the above embodiments is implemented by a computer 900 having a configuration as illustrated in FIG. 25, for example.

FIG. 25 is a hardware configuration diagram illustrating an example of the computer 900 that implements the functions of the power saving function control device 100 or 100A (FIGS. 2A, 2B, 5A, and 5B).

The computer 900 includes a CPU 901, a ROM 902, a RAM 903, an HDD 904, a communication interface (I/F) 906, an input/output interface (I/F) 905, and a media interface (I/F) 907.

The CPU 901 operates on the basis of a program stored in the ROM 902 or the HDD 904, and controls each unit of the power saving function control device 100 or 100A (FIGS. 2A, 2B, 5A, and 5B). The ROM 902 stores a boot program to be executed by the CPU 901 when the computer 900 is activated, a program depending on the hardware of the computer 900, and the like.

The CPU 901 controls, via the input/output I/F 905, an input device 910 such as a mouse or a keyboard, and an output device 911 such as a display. Via the input/output I/F 905, the CPU 901 acquires data from the input device 910, and outputs generated data to the output device 911. Note that a graphics processing unit (GPU) or the like may be used as a processor in conjunction with the CPU 901.

The HDD 904 stores a program to be executed by the CPU 901, data to be used by the program, and the like. The communication I/F 906 receives data from another device via a communication network (for example, a network (NW) 920), outputs the data to the CPU 901, and transmits data generated by the CPU 901 to another device via the communication network.

The media I/F 907 reads a program or data stored in a recording medium 912, and outputs the program or data to the CPU 901 via the RAM 903. The CPU 901 loads a program related to target processing from the recording medium 912 into the RAM 903 via the media I/F 907, and executes the loaded program. The recording medium 912 is an optical recording medium such as a digital versatile disc (DVD) or a phase change rewritable disk (PD), a magneto-optical recording medium such as a magneto-optical disk (MO), a magnetic recording medium, a conductor memory tape medium, a semiconductor memory, or the like.

For example, in a case where the computer 900 functions as the power saving function control device 100 or 100A (FIGS. 2A, 2B, 5A, and 5B) configured as one device according to the present embodiment, the CPU 901 of the computer 900 implements the functions of the power saving function control device 100 or 100A by executing a program loaded on the RAM 903. In addition, the HDD 904 stores data in the RAM 903. The CPU 901 reads a program related to target processing from the recording medium 912, and executes the program. Additionally, the CPU 901 may read a program related to target processing from another device via the communication network (NW 920).

### [Effects]

As described above, provided is a power saving function control device (active core number controller 100) that controls a power saving function of a power saver (CC-state controller 130) in a control target server 70 of a calculation system (wireless system 1) that reduces a power consumption amount by gradually reducing an operating state of a processor according to a processing load, the power saving function control device including a rule accumulator 110 that accumulates a rule for a power saving function for each control target server 70 acquired from the outside, and a rule reflector 120 that performs power saving function control reflecting the rule on the power saver in accordance with the rule accumulated in the rule accumulator 110.

Here, the control target server 70 acquires a rule stored in the control device 20, which is another server arranged outside, from the outside, and accumulates the rule in the rule accumulator 110. Any server may be used as long as the control target server 70 acquires the rule for the power saving function from another server arranged outside. The rule stored in the control device 20 may be those set by an operator or those set by another system, for example. Since the control target server 70 accumulates the rule acquired from the outside in the rule accumulator 110, the control target server 70 does not generate the rule for the power saving function using its own resource, thereby reducing the processing load for generating the rule.

By performing the power saving function control reflecting the rules accumulated in the rule accumulator 110, the control target server 70 can reduce power consumption without causing delays in the power saving function control (for example, CPU power mode control, control using a power capping function, or the like) of the CPU.

The power saving function control device (active core number controller 100) includes a CPU usage rate acquisitor 140 that acquires a CPU usage rate, and a traffic volume acquisitor 150 that distinguishes between UpLink and DownLink and collects an amount of passing data according to a predefined setting determined in advance, and the rule reflector 120 reflects the acquired CPU usage rate and/or traffic in the rule.

In this way, the power saving function control device can reflect the CPU usage rate and the traffic in the rule, and can effectively implement the power saving function control (for example, CPU power mode control, control using a power capping function, or the like) of the CPU. Accordingly, power consumption can be further reduced without causing delays.

Provided is a calculation system including a control target server 70 including a power saver that reduces a power consumption amount by gradually reducing an operating state of a processor according to a processing load, and a control device 20 that controls the control target server 70, the control device 20 includes a rule storage 210 that stores a rule for a power saving function for each control target server 70, and the control target server 70 includes a rule accumulator 110 that accumulates the rule for the power saving function for each control target server 70 acquired from the rule storage 210 of the control device 20, and a rule reflector 120 that performs power saving function control reflecting the rule on the power saver in accordance with the rule accumulated in the rule accumulator 110.

In this way, the control device 20 can collect a rule for the power saving function for each control target server 70, update the rule on the basis of the collected data, and send the rule to the corresponding control target server 70. The control target server 70 can receive the latest rule from the control device 20 and update the rule in the rule accumulator 110. As a result, power consumption can be reduced without causing delays in CPU power mode control and control using the power capping function.

In the calculation system (wireless system 1), the control target server 70 includes a CPU usage rate acquisitor 140 that acquires a CPU usage rate, and a traffic volume acquisitor 150 that distinguishes between UpLink and DownLink and collects an amount of passing data according to a predefined setting determined in advance, and the control device 20 includes a data accumulator 230 that accumulates information on a CPU core usage rate (FIG. 9), a data amount (FIG. 10), and/or the number of connected terminals (FIG. 11) of each control target server 70 collected from the control target server 70, and a rule generator 250 that updates the rule stored in the rule storage 210 on the basis of the information accumulated in the data accumulator 230.

In this way, the control device 20 can collect the rule for the power saving function for each control target server 70 and accumulate the rule in the data accumulator 230, and the rule generator 250 can generate and update rules on the basis of the information accumulated in the data accumulator 230. The control target server 70 can receive the latest generated rule from the control device 20 and update the rule in the rule accumulator 110. As a result, power consumption can be further reduced without causing delays in CPU power mode control and control using the power capping function.

In the calculation system (wireless system 1), the control device 20 includes a required core number estimator 240 that acquires desired data from the data accumulator 230, estimates a required number of CPU cores according to various conditions, and passes a combination of the condition and the required number of CPU cores, which is an estimation result, to the rule generator 250.

In this way, the control device 20 can estimate the required number of cores according to various conditions. Accordingly, the rule generator 250 can update the rule using the combination of the estimated required numbers of cores and generate a more appropriate rule.

In the calculation system (wireless system 1), the control device 20 includes a DU attribute estimator 260 that acquires desired data from the data accumulator 230 and estimates a DU attribute.

In this way, by estimating the DU attribute, the calculation system can send the optimum rule to each control target server 70, and can reduce the power consumption without causing delays in the CPU power mode control and the control using the power capping function in each control target server 70.

Note that, among processing operations described in each of the above embodiment, all or some of processing operations described as being automatically performed can be manually performed, or all or some of processing operations described as being manually performed can be automatically performed by a known method. In addition, processing procedures, control procedures, specific name, and information including various types of data and parameters illustrated in the specification and the drawings can be arbitrarily changed unless otherwise specified.

In addition, each component of each device that has been illustrated is functionally conceptual, and is not necessarily physically configured as illustrated. That is, a specific form of distribution and integration of individual devices is not limited to the illustrated form, and all or a part of the configuration can be functionally or physically distributed and integrated in any unit according to various loads, usage conditions, and the like.

Further, some or all of the component, functions, processors, processing means, and the like described above may be implemented by hardware, for example, by designing them in an integrated circuit. Also, the respective components, functions, and the like may be implemented by software for interpreting and executing a program for causing a processor to implement the respective functions. Information such as a program, a table, and a file for implementing the respective functions can be held in a recording device such as a memory, a hard disk, or a solid state drive (SSD), or in a recording medium such as an integrated circuit (IC) card, a secure digital (SD) card, or an optical disc.

### REFERENCE SIGNS LIST

1 Wireless system
2 Terminal [UE]
3 Radio unit [RU]
4 User space
10 Base station
20 Control device
30 Aggregation device [CU]
50 Hardware (HW)
51, 52 NIC
53 CPU
70 Control target server [DU]
71 Interface
72 Processor
74 Control device communicator
80 DPDK
81 PMD
100 Active core number controller (power saving function control device)
110 Rule accumulator
120 Rule reflector
130 CC-state controller (power saver)
220 Control target server information collection IF
230 Data accumulator
240 Required core number estimator
250 Rule generator
260 DU attribute estimator
CPUcore #0, CPUcore #1, . . . . CPU core

1. A power saving function control device that controls a power saving function of a power saver in a control target server of a calculation system that reduces a power consumption amount by gradually reducing an operating state of a processor according to a processing load, the power saving function control device comprising:
a rule accumulator that accumulates a rule for a power saving function for each control target server acquired from the outside; and
a rule reflector that performs power saving function control reflecting the rule on the power saver in accordance with the rule accumulated in the rule accumulator.

2. The power saving function control device according to claim 1, comprising:
a CPU usage rate acquisitor that acquires a CPU usage rate; and
a traffic volume acquisitor that distinguishes between UpLink and DownLink and collects an amount of passing data according to a predefined setting determined in advance,
wherein the rule reflector reflects the acquired CPU usage rate and/or traffic in the rule.

3. A calculation system comprising: a control target server including a power saver that reduces a power consumption amount by gradually reducing an operating state of a processor according to a processing load; and a control device that controls the control target server,
wherein the control device includes
a rule storage that stores a rule for a power saving function for each control target server, and
the control target server includes:
a rule accumulator that accumulates the rule for the power saving function for each control target server acquired from the rule storage of the control device; and
a rule reflector that performs power saving function control reflecting the rule on the power saver in accordance with the rule accumulated in the rule accumulator.

4. The calculation system according to claim 3,
wherein the control target server includes:
a CPU usage rate acquisitor that acquires a CPU usage rate; and
a traffic volume acquisitor that distinguishes between UpLink and DownLink and collects an amount of passing data according to a predefined setting determined in advance, and
the control device includes:
a data accumulator that accumulates information on a CPU core usage rate, a data amount, and/or the number of connected terminals of each control target server collected from the control target server; and
a rule generator that updates the rule stored in the rule storage on the basis of the information accumulated in the data accumulator.

5. The calculation system according to claim 4,
wherein the control device includes
a required core number estimator that acquires desired data from the data accumulator, estimates a required number of CPU cores according to various conditions, and passes a combination of the condition and the required number of CPU cores, which is an estimation result, to the rule generator.

6. The calculation system according to claim 4,
wherein the control device includes a DU attribute estimator that acquires desired data from the data accumulator and estimates a DU attribute.

7. A power saving function control method of a power saving function control device that controls a power saving function of a power saver in a control target server of a calculation system that reduces a power consumption amount by gradually reducing an operating state of a processor according to a processing load, the power saving function control method comprising:
a step of accumulating, by the power saving function control device, a rule for a power saving function for each control target server acquired from the outside; and
a step of performing, by the power saving function control device, power saving function control reflecting the rule on the power saver in accordance with the accumulated rule.

8. A non-transitory storage medium storing a program for causing a computer to function as the power saving function control device according to claim 1.
